(19) United States
(12) Patent Application Publication
(10) Pub. No.: US 2016/0063190 A1
(43) Pub. Date: Mar. 3, 2016

(54) COMPUTER IMPLEMENTED PERSONALIZED HEALTH RECORD SYSTEM AND A METHOD THEREOF

(71) Applicant: Nilesh Satish Kanade, Maharashtra (IN)

(72) Inventors: Rupa Nilesh Kanade, Maharashtra (IN); Nilesh Satish Kanade, Maharashtra (IN)

(21) Appl. No.: 14/844,159

(22) Filed: Sep. 3, 2015

Related U.S. Application Data
(60) Provisional application No. 62/100,750, filed on Jan. 7, 2015.

(30) Foreign Application Priority Data
Sep. 3, 2014 (IN) 2809/MUM/2014

(51) Int. Cl. G06F 19/00

(52) U.S. Cl. CPC G06F 19/323; G06F 19/328

(57) ABSTRACT

A computer implemented personalized health record system and method is envisaged. The system provides smart cards to profile registrants on registration, which are associated with the profile registrants' health records and have a unique identification number corresponding to every profile registrant. The system stores profile registrants' information along with their health records and demographic information and associates it with their corresponding unique identification numbers. The demographic information can be edited/updated by a profile registrant on successful authentication. When a profile registrant visits a health facility/laboratory, after successful two level authentications, an authenticated health registrant is able to access health records of the authenticated profile registrant and medical history along with profile registrant's demographic information in order to provide a better diagnosis/treatment. Any treatment details after the diagnosis and/or prescription provided by the physician and the test results from the laboratory are then updated in the system through a network.

### TECHNICAL FIELD

The present disclosure relates to the field of providing, maintaining and updating health records.

### DEFINITIONS OF TERMS USED IN THE SPECIFICATION

The expression ‘registrant’ used hereinafter in this specification refers to a person using the personalized health record system after registration.

The expression ‘profile registrant’ used hereinafter in this specification refers to a healthy or sick entity that may want to visit a medical center, doctor, hospital, pathology laboratory, pharmacy, chemists veterinary laboratory and the like or may want to view his/her own health record or the health record of an animal or a pet associated with such a registrant. The health record may be in relation to a person or to an animal such as a pet associated with a person. The registrant may require such a health record to be viewed or updated by a medical practitioner, a pathologist or a medical technician/attendant/nurse as the case may be.

The expression ‘health registrant’ used hereinafter in this specification refers to a medical professional and may include a doctor, a physician, a vet or a paramedic/nurse, a physician's assistant or a medical administrator that uses the personalized health record system to view and/or update profile registrants medical records for the purposes of diagnosis and/or treatment.

These definitions are in addition to those expressed in the art.

### BACKGROUND

Maintaining health records is a known practice. Health professionals keep track of their patient's medical history/records. Such health records usually include information related to patients' allergies, observations, diagnoses and treatments along with success and failure of suggested treatments. This method builds and strengthens the trust in doctor-patient relationships. Sometimes, patients need to change their primary location and therefore need to establish a relationship with a new health professional. Establishing such a new relationship with a new health professional/healthcare provider can be complicated since a patient's complete medical records must be physically transferred to the new health professional/healthcare provider. Additionally, any health insurance details and changes related to the same must also be conveyed. Even after this there is a possibility that the records remain incomplete due to patients'/doctors' failure in remembering all necessary medical or health related information. Sometimes, patients may even convey incorrect information which may result in an improper diagnosis affecting their health. In some cases, particularly in an emergency such as an accident or a calamity, a patient may not be able to communicate with a health professional and vice versa, and in such cases there is a need of a system by which a health professional should be able to obtain the records of such a patient who is stranger to him/her so that the professional can attend to the potential patient with diligence.

Thus, it is evident from the aforementioned drawbacks that there is a need for a system that preserves and provides health records anywhere on the fly, irrespective of place and time.

### OBJECTS

Some of the objects of the present disclosure aimed to ameliorate one or more problems of the prior art or to at least provide a useful alternative are listed herein below.

An object of the system of the present disclosure is to provide a personalized health record system that can be accessed by registrants/health professionals/patients irrespective of their location.

Another object of the present disclosure is to provide a system that allows access to health records for medical response/diagnosis/treatment.

Still another object of the present disclosure is to provide a system that stores, provides and updates health records irrespective of place and time.

One more object of the present disclosure is to provide a system that is configured to connect to different medical centers, doctors, hospitals, pathology laboratories, chemists and insurance providers.

Yet another object of the present disclosure is to provide a system that enables secure remote access to health records of patients.

An additional object of the present disclosure is to provide a system that enables multi-regional, multi-lingual, multi-medical-coded and multi-platform support.

Further, an object of the present disclosure is to provide a system that enables ease of access to health records in case of emergency situations.

Other objects and advantages of the present disclosure will be more apparent from the following description when read in conjunction with the accompanying figures, which are not intended to limit the scope of the present disclosure.

### SUMMARY

The present disclosure envisages a computer implemented personalized health record system and a method thereof. In one embodiment the personalized health record system comprises a plurality of smart cards and a server. Each of the smart card has a unique identification number and is associated with a profile registrant. The server comprises a registration module which registers health registrants and profile registrants. It also comprises a digital chest of drawers, which includes a first set of digital drawers to store health records, a unique identification number and a password associated with each profile registrant, a second set of digital drawers to store professional records including area of specialization and authentication credentials of each health registrant, and a third set of digital drawers to store a plurality of interfaces, such that each interface is linked to at least one platform thereby enabling the digital chest of drawers to be accessed by a plurality of platforms. The server also includes an accessing module, an identifier, a first authenticator, a second authenticator, at least one crawler and extractor, a display and an updater. The accessing module permits profile registrants and health registrants to access the digital chest of drawers on a registrant's selected platform to enable a profile registrant to view his/her health record and enables a health registrant to view and update a selected profile registrant's health record. The identifier identifies a suitable interface from the plurality of interfaces stored in the third set of digital drawers to interface the selected platform with the system. The first authenticator authenticates profile registrants and the second authenticator authenticates health registrants. The at least one crawler and extractor extracts health record of an authenticated profile registrant and professional record of an authenticated health registrant which are then displayed using the display module. The display module cooperates with the at least one crawler and extractor to enable display of the extracted health record of the authenticated profile registrant either on a display device of the authenticated profile registrant and/or of the authenticated health registrant, and the updater accepts health records, professional records and interfaces, and updates the digital chest of drawers based on the accepted health records, professional records and interfaces.

This summary is provided to introduce concepts related to the personalized health record system, which is further described below in the detailed description. This summary is neither intended to identify essential features of the present disclosure nor is it intended for use in determining or limiting the scope of the present disclosure.

### BRIEF DESCRIPTION OF ACCOMPANYING DRAWING

A computer implemented personalized health record system and a method thereof will now be explained in relation to the non-limiting accompanying drawing, in which:

FIG. 1 illustrates a schematic of an embodiment of a personalized health record system; and

FIG. 2 illustrates a flow diagram of an embodiment of a method of implementing the personalized health record system.

### DETAILED DESCRIPTION OF THE ACCOMPANYING DRAWING

The system herein and the various features and advantageous details thereof are explained with reference to the non-limiting embodiments in the following description. Descriptions of well-known parameters and processing techniques are omitted so as to not unnecessarily obscure the embodiment herein. The examples used herein are intended merely to facilitate an understanding of ways in which the embodiment herein may be practiced and to further enable those of skill in the art to practice the embodiment herein. Accordingly, the examples should not be construed as limiting the scope of the embodiment herein.

In accordance with the present disclosure, the personalized health record system enables individual practitioners like doctors, physicians, nurses, dentists, pharmacists, health professionals and other entities to access and update health records and other related information stored in the system. The stored information and health records can only be accessed by registrants. The registrants are entities that have registered to the system. These registrants are categorized into profile registrants and health registrants. The profile registrants are sick or healthy persons or persons related to sick or healthy animals/pets that have successfully completed a registration process. For successful registration, a potential profile registrant needs to provide his/her demographic information including blood type, food allergies, contact details, sensitivities to certain medicines, next of kin data and the like. This demographic information related to the potential profile registrant is accepted and stored by the system in a sub-drawer from a first set of digital drawers present in a digital chest of drawers. A unique identification number is then allotted to the potential profile registrant and he/she is requested to select a pin number/password. The allotted unique identification number and the selected pin number/password is then associated to the potential profile registrant and stored in the first set of digital drawers. A smart card is issued to the potential profile registrant to complete the registration process. The issued smart card is coded with the profile registrant's demographic information and the unique identification number. In one embodiment, the smart card is rewritable and includes profile registrant's medical information along with the demographic information in form of text. Further, web services can be used to modify/change the medical information on the rewritable smart card. Once a unique identification number is established in relation to a profile registrant, the profile registrant and/or a health registrant can store previous health records related to the profile registrant in the system. These health records are stored in the first set of digital drawers for future access.

The health registrants are doctors/nurses/health professionals/health technicians that have successfully registered to the system. In case of health registrants, for registration, a potential health registrant is required to provide his/her professional records including area of specialization and a practitioner number. This information can then be verified by the system by checking for the authenticity of information from a relevant medical council/government body. In one embodiment, the authenticity of professional records and other information provided by a potential health registrant is checked by comparing the provided information with document(s) given by a relevant medical council/government body. On verification, the potential health registrant is registered by storing his/her professional records in a second set of digital drawers present in the digital chest of drawers. The practitioner number provided by the health registrant at the time of registration can be used by him/her for authentication in order to access information related to a profile registrant. In one embodiment, a password can be selected by a health registrant during the registration process for authentication.

When a smart card is read, a two level authentication needs to be completed to access the stored information and records. For the first level of authentication, the system identifies a unique identification number associated to the smart card and requests a profile registrant having the smart card to input his/her password/pin number that was set during the registration process. The accepted password/pin number is then compared with the password/pin number stored in the first set of digital drawers to authenticate the profile registrant. On successful authentication, demographic information of the authenticated profile registrant stored in the sub-drawer of the first set of digital drawers is displayed. This information can be used by a potential health registrant to treat the authenticated profile registrant in case of an emergency situation. However, to access the stored demographic information of the authenticated profile registrant in case of emergency situations, a potential health registrant is compelled to perform a quick registration wherein his/her basic professional details and/or his/her practitioner number and/or credentials of an institution where he/she is practicing are accepted by the system and stored in the second set of digital drawers. These details can be verified by the system and then an access to the authenticated profile registrant's demographic information and/or health records can be provided. The potential health registrant can later complete the registration process by providing his/her complete professional records. On successful complete registration, a health registrant can access stored health records of profile registrants and update the stored health records and/or include new health records obtained after diagnosis and/or treatment.

The system includes an interface module which selects a suitable interface from a plurality of interfaces stored in a third set of digital drawers present in the digital chest of drawers depending on the system addressed by registrants. For example, if a health record or information to be accessed in is form of a word file and an ‘Apple’ system/computer is used to access the health records/information, a suitable interface is selected from the stored plurality of interfaces to enable seamless access to the stored information and records irrespective of platform. Based on a system that is used for accessing the stored records and/or information, an interface is extracted either from the third set of digital drawers or from external sources and built to act as a communicator. This enables the registrants to access stored records and information irrespective of the platform that is being used by them.

In another embodiment, the system includes insurance provider's information and details related to a profile registrant's insurance cover. Based on this information, the system automatically links the insurance information to provide relevant cover to the profile registrant based on current diagnosis/treatment. The information related to profile registrants' health, diagnosis and test results can be updated only by an authorized health registrant. In one embodiment, a profile registrant uploads his demographic information along with his social history including the exercise performed and diet followed by the profile registrant in order to allow relevant diagnosis and treatment.

The disclosure will now be described with reference to the accompanying non-limiting drawing which illustrates one embodiment of the personalized health record system. The embodiment does not limit the scope and ambit of the disclosure. The description relates purely to the examples and preferred embodiments of the disclosed system and its suggested applications.

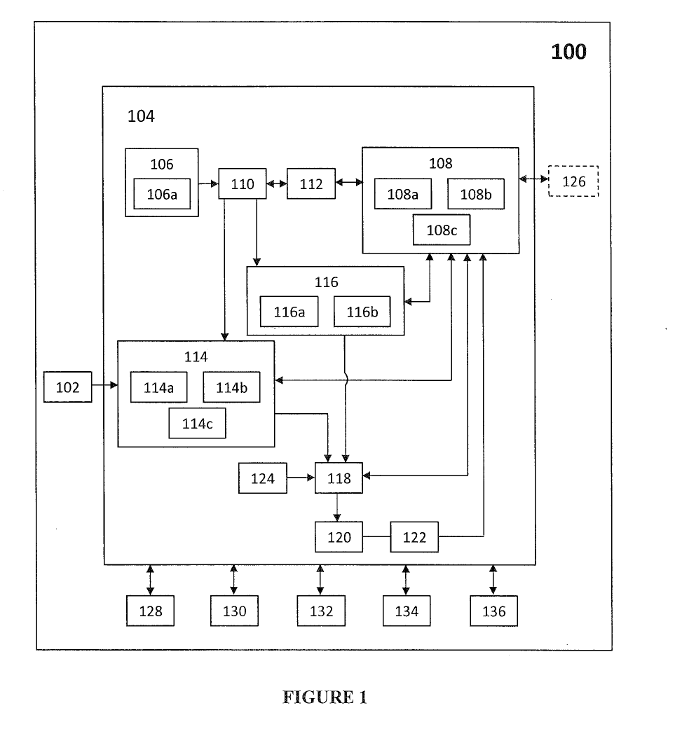

Referring to the accompanying drawing, FIG. 1 illustrates a schematic of an embodiment of a personalized health record system 100 that maintains, provides and updates health records anywhere anytime. The system 100 includes a server 104 which stores all health history related to profile registrants along with relevant additional information like insurance providers and details related to insurance covers for a particular profile registrant. In one embodiment, the system 100 automatically links the stored insurance related information to provide relevant insurance covers to profile registrants. The server 104 includes a digital chest of drawers 108 to store information related to profile registrants, health registrants and various interfaces that may be required by the system 100. The digital chest of drawers 108 includes a first set of digital drawers 108a, a second set of digital drawers 108b and a third set of digital drawers 108c. The first set of digital drawers 108a stores demographic information, health records, a unique identification number and a password associated with each profile registrant, the second set of digital drawers 108b stores professional records including area of specialization and authentication credentials of each health registrant, and the third set of digital drawers 108c stores a plurality of interfaces such that each interface is linked to at least one platform thereby enabling the digital chest of drawers 108 to be accessed by a plurality of platforms. In an embodiment, the first set of digital drawers 108a includes a set of sub-drawers which store demographic information related to profile registrants. The system 100 can be accessed by the profile registrants to update this demographic information which may be helpful during diagnosis/treatment. The stored information and records can only be accessed and/or updated by authenticated registrants.

A registration module 106 is included in the server 104 to enable users/potential registrants to register in order to access the stored information/records. During the registration process a registrant provides needed data and proof of completion and correctness of the data. The registration module 106 includes a first input module 106a which accepts this data along with demographic information, credentials and health records of the profile registrants, and professional records of health registrants. For example, if a potential profile registrant is accessing the system 100 for the first time, he/she provides demographic information along with an accepted proof of ID for further reference. When a health registrant registers to the system, he/she needs to provide professional records including area of specialization and other authentication credentials like practitioner number. On successful registration, a profile registrant is provided with a personalized smart card 102 having a 16-digit unique identification number and a pin number/password to log into the system 100. In one embodiment, the smart card 102 is encoded with information related to the profile registrant including his/her identification information. The server 104 includes an accessing module 110 that permits profile registrants and health registrants to access the digital chest of drawers 108 on a registrant's selected platform. In order to provide access on the registrant's selected platform, the server 104 includes an identifier 112 which identifies a suitable interface from the plurality of interfaces stored in the third set of digital drawers 108c to interface the selected platform with the system 100. In one embodiment, if a suitable interface is not stored in the third set of drawers 108c, the system 100 extracts the suitable interface from external sources, and updates the third set of drawers 108c to include the extracted suitable interface. The registrants are then authenticated to enable a secure access to the stored information and records. The server 104 includes a first authenticator 114 to authenticate profile registrants and a second authenticator 116 to authenticate health registrants. On successful authentication, the profile registrant is able to view his/her health record and demographic information and the health registrant is able to view demographic information and health record and update a selected profile registrant's health record. In one embodiment, the registrants access the system 100 through a device irrespective of the place and time over a network with the help of the unique credentials (identification number and pin number) and/or the authentication credentials to update stored information/records.

When a profile registrant is ill and needs a doctor's opinion/treatment or he/she needs to undergo pathological tests, the profile registrant produces his/her personalized smart card 102 (provided after registration in the system 100) at a medical facility/clinic. A smart card reader 114a present in the first authenticator 114 is installed at recognized medical facilities including hospitals, clinics, pathology labs and the like. In one embodiment, the smart card reader 114a is a handheld device that need not be fixed or installed in the medical facility. The smart card 102 when produced by the profile registrant is read using the smart card reader 114a to identify the unique identification number associated with the smart card 102. The profile registrant then provides his/her pin number/password to allow a health registrant/concerned authorized person to view his/her demographic information. This serves as a first level of authentication wherein on successful authentication the health registrant is able to view basic demographic information related to the profile registrant's health on a display. The first authenticator 114 present in the system 100 prompts the profile registrant to input a valid pin number/password corresponding to the recognized unique identification number after the smart card 102 is successfully read by the smart card reader 114a. A second input module 114b present in the first authenticator 114 accepts the pin number/password from the profile registrant and provides it to a first comparator 114c to confirm whether the profile registrant is registered user. The first comparator 114c compares the accepted password with the passwords stored in the first set of digital drawers 108a to authenticate the profile registrant. If the compared pin numbers/passwords match, the first authenticator 114 authenticates the profile registrant thus providing a successful first level authentication. In one embodiment, on successful first level authentication, the system 100 provides demographic information related to the authenticated profile registrant to a health registrant/medical facility. This demographic information includes basic information related to the profile registrant and details of the profile registrant including the profile registrant's blood group, allergies and the like. This proves to be advantageous in case of emergency situations where the doctors have to treat a profile registrant in a critical condition. In another embodiment, a doctor/health professional/potential health registrant who is not registered with the system 100 needs to complete a basic registration process to view a profile registrant's demographic information in case of emergency situation. The potential health registrant can later complete the registration process to view and update a profile registrant's health records. The basic registration process requires a potential health registrant to provide/input his/her practitioner number and/or registration number of a medical facility where he/she is practicing. This information is then verified by the system 100 before providing access to profile registrants' information.

If a health professional is a health registrant, on completion of a first level of authentication, the health registrant is prompted to provide his/her authentication credentials in order to access the profile registrant's health records. The authentication credentials for the health registrant/medical practitioner/lab technician include a registration/practitioner number provided by a medical council of the country where the doctor is practicing. A third input module 116a present in the second authenticator 116 accepts the authentication credentials from the health registrant and provides them to a second comparator 116b. The second comparator 116b then compares the accepted authentication credentials with the authentication credentials stored in the second set of digital drawers 108b to authenticate the health registrants thereby providing a second level of authentication. In one embodiment, the authentication credentials are obtained from a repository of a medical council 126 of a particular country to authenticate the health registrant of that country wanting to access the health records of a profile registrant.

The server 104 includes at least one crawler and extractor 118 that extracts health record of an authenticated profile registrant and professional record of an authenticated health registrant from the digital chest of drawers 108 after successful authentications. For this, the crawler and extractor 118 cooperates with the first authenticator 114 to receive a unique identification number of an authenticated profile registrant and then crawls through the first set of digital drawers 108a to extract the health record of the authenticated profile registrant. The crawler and extractor 118 also cooperates with the second authenticator 116 to receive authentication credentials of an authenticated health registrant and then crawls through the second set of digital drawers 108b to extract the professional record of the authenticated health registrant. A display module 120 present in the server 120 then cooperates with the at least one crawler and extractor 118 to enable display of the extracted health record of the authenticated profile registrant either on a display device of the authenticated profile registrant and/or of the authenticated health registrant. This information is then utilized by the authenticated health registrant to better diagnose and treat the authenticated profile registrant. In one embodiment, the display module 120 enables display of the extracted professional records including area of specialization of authenticated health registrants. The authenticated health registrants/concerned authorized persons can update/edit the health records of the profile registrants stored in the first set of digital drawers 108a for future use after successful authentication with the help of an updater 122. In one embodiment, the updater 122 also allows the authenticated profile registrants to edit respective demographic information stored in the digital chest of drawers 108. The updater 122 is configured to accept health records, professional records and interfaces and update the digital chest of drawers by storing the accepted accept health records, professional records and interfaces. The system 100 allows progressive non-tamperable uploading of records. In one embodiment, the server 104 comprises a sorter 124 that cooperates with the at least one crawler and extractor 118 to sort extracted health records based on the area of specialization of an authenticated health registrant. In another embodiment, the sorter 124 sorts the health records based on a pre-determined set of rules and/or a pre-determined preference. For example, if a health registrant is an Ayurvedic doctor, extracted health records related to a profile registrant are sorted to first display Ayurveda related records or other related information of the profile registrant. The sorter 124 also sorts health records to display earlier treatments and allergies of a profile registrant.

In an embodiment, the smart card 102 includes a profile registrant's photograph to avoid fraudulent usage, profile registrant's blood group in case of emergencies and emergency contact number(s). In case of an emergency or a critical situation where the profile registrant is not in a condition to provide his/her pin number/password, the health registrant or the concerned authorized person contacts the emergency number(s) provided on the smart card 102 and retrieves the pin number/password for that profile registrant to allow an immediate treatment without having to wait for the relatives/friends to provide the relevant important information for the treatment. In another embodiment, in case of emergency a concerned person can view basic information of the profile registrant by using the system 100, in order to provide basic care/treatment. This saves time in gathering the required information and the health registrant/doctor is able to operate/treat the profile registrant efficiently. In yet another embodiment, when the profile registrant forgets to carry his/her smart card 102 to the clinic/hospital/pathology lab, the profile registrant only provides the unique identification number associated to the smart card 102 and requests an online pin/one time password from the system 100 in order to complete first level authentication. The system 100 includes a customer service module 128 that provides an online pin/one time password to the profile registrant after the profile registrant satisfactorily answers pre-determined authentication questions. This online pin/one time password is then accepted by the first authenticator 114 to authenticate the profile registrant and display his/her demographic details/basic health related information.

In another embodiment, the system 100 suggests a suitable insurance plan and/or a nearby healthcare provider/center to profile registrants based on the demographic information and demands of the profile registrants. In yet another embodiment, the system 100 is accessed by end users including government bodies, institutions, hospitals and the like. Citizens of a government register themselves to use the system 100 by linking an existing card system (for example, a driver's license of country) to a personalized smart card provided by the system 100. This allows the system 100 of the present disclosure to readily utilize the relevant available information to track health history of profile registrants that are frequent travelers or temporary immigrants. The system 100 can also be utilized by hospitals, pharmacies, chemists, pathology sections and the like.

Further, in one embodiment, a profile registrant requests an appointment with a particular health registrant or lab technician with the help of this system 100 and the health registrant or lab technician accepts the appointment or re-schedules it based on the convenience of both profile registrant as well as the health registrant/lab technician. The information related to the visit along with diagnosis information and subsequent information related to test results/prescribed medicines is then stored in the digital chest of drawers 108 against the profile registrant's unique identification number for future use. This allows different health registrants treating a common profile registrant to carry out mutual discussions with the line of diagnosis. The system 100 also enables the health registrants to store their notations and finding related to treatment/diagnosis of profile registrants. In an embodiment, the profile registrant views the information/health registrant's comments after his/her diagnosis at his/her ease. These comments can also be viewed by another health registrant in future so as to enable the health registrant to provide a better diagnosis based on a profile registrant's health history. For this, the system 100 provides a multi-medical-coded support that enables sharing and processing of health records and other information in a uniform and consistent manner. This allows health registrants and/or profile registrants to use different devices/computer systems to input health records and other information in formats convenient to the registrants. In one embodiment, the system 100 includes automated Health Level-7 (HL7) generation capability wherein numerous standards and guidelines are followed to allow different health registrants to communicate with each other for mutual discussions and diagnosis.

The system 100 also includes a training module 130 in order to train doctors and the support staff. The training module 130 provides an understanding of the system 100 and how it must be utilized for benefit of profile registrants as well as health registrants. The training module includes training related to a scheduler management, managing profile registrant directory, OPD interface, consultation second opinion use, data updating and retrieval and the like. If a health registrant is a pathologist the training module 130 provides training on sample collection, data updating, volume data management, inventory management and the like. The system 100 also provides medicine delivery to health registrants or profile registrants who request the medicine delivery through the system 100. On medicine delivery, the pharmacists can notify the profile registrants and health registrants to make necessary changes to the information in the digital chest of drawers 108. An illness information management module 132 present in the system 100 provides profile registrant self-management support and decision support information of various diseases. The profile registrant self-management support allows profile registrant record keeping and profile registrant goal setting which helps a profile registrant to maintain, track and achieve a health goal. The illness information management module 132 includes a chronic disease registry as well as information related to health registrants/pathologists known in their fields of speciality. The customer service module 128 present in the system 100 provides technical support if the registrants of the system 100 faces any problem during the use. In an embodiment, the support is multi-lingual and is provided as an automated response or a human assistance. In another embodiment, the system 100 automatically translates the records in a language preferred by a registrant or based on the location of the registrant using the system 100. The system 100 further includes a knowledge processing unit 136 that focusses on Workforce Optimization, Quality Monitoring, Recording, Workforce Management, Performance Management, Desktop and Process Analytics, eLearning, Coaching, Speech Analytics, Text Analytics, Enterprise Feedback Management, Customer Feedback Surveys, Fraud Prevention and Identity Authentication, and the like. The system 100 also includes a vendor management module 134 that facilitates joining of other medical systems with the system 100 of the present disclosure. For example, if an X-ray machines which give output in .jpeg or .png format with written description is developed by someone, a step of scanning the X-ray records can be minimized if that system is integrated with the system 100 of the present disclosure as long as it complies with medical regulations. Therefore, the system 100 can be used on any platform and is configured to be integrated with other medical systems.

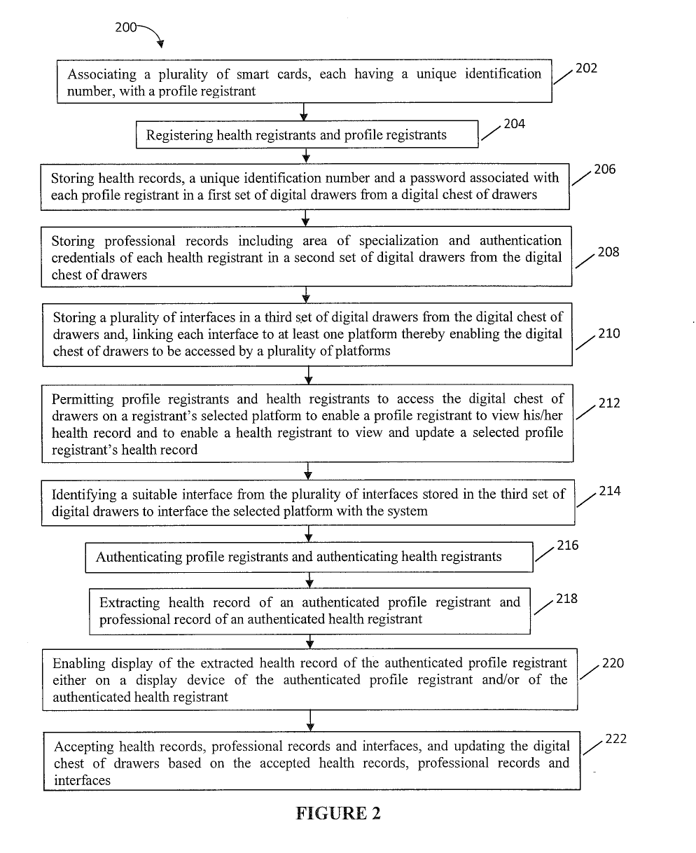

Referring to the accompanying drawing, FIG. 2 illustrates a flow diagram of an embodiment of a method 200 of implementing the personalized health record system. A smart card is provided to every profile registrant on registration. The method 200 includes associating a plurality of smart cards, each having a unique identification number, with a profile registrant 202. These smart cards are encoded with information related to the profile registrant like profile registrant's identification information. Health registrants and profile registrants can use the system after registration 204. The step of registering health registrants and profile registrants 204 includes steps of accepting demographic information, credentials and health records of the profile registrants, and professional records of the health registrants, for registration. The method 200 includes steps of storing health records, a unique identification number and a password associated with each profile registrant in a first set of digital drawers from a digital chest of drawers 206, storing professional records including area of specialization and authentication credentials of each health registrant in a second set of digital drawers from the digital chest of drawers 208, and storing a plurality of interfaces in a third set of digital drawers from the digital chest of drawers and, linking each interface to at least one platform thereby enabling the digital chest of drawers to be accessed by a plurality of platforms 210. In one embodiment, the step of storing authentication credentials of health registrants includes step of obtaining authentication credentials from a repository of a medical council. In order to provide access to the system, the method 200 includes step of permitting profile registrants and health registrants to access the digital chest of drawers on a registrant's selected platform to enable a profile registrant to view his/her health record and to enable a health registrant to view and update a selected profile registrant's health record 212. The method 200 also includes identifying a suitable interface from the plurality of interfaces stored in the third set of digital drawers to interface the selected platform with the system 214. In one embodiment, identifying a suitable interface includes a step of extracting a suitable interface from external sources, if a suitable interface is not stored in the third set of digital drawers, and updating the third set of digital drawers to include the extracted suitable interface.

When a profile registrant visits a health facility/clinic, he/she presents the smart card to a concerned person/physician. In order to provide access, the method 200 includes steps of authenticating profile registrants and health registrants 216. The step of authenticating profile registrants includes reading the plurality of smart cards and identifying unique identification numbers of the smart cards, accepting passwords from the profile registrants, and comparing the accepted passwords with the passwords stored in the first set of digital drawers to authenticate the profile registrants. The step of authenticating health registrants includes accepting authentication credentials from the health registrants, and comparing the accepted authentication credentials with the authentication credentials stored in the second set of digital drawers to authenticate the health registrants. On successful authentications, the method 200 includes steps of extracting health record of an authenticated profile registrant and professional record of an authenticated health registrant 218 and enabling display of the extracted health record of the authenticated profile registrant either on a display device of the authenticated profile registrant and/or of the authenticated health registrant 220. The step of extracting health record and professional record 218 includes steps of receiving a unique identification number of an authenticated profile registrant and crawling through the first set of digital drawers to extract the health record of the authenticated profile registrant, and receiving authentication credentials of an authenticated health registrant and crawling through the second set of digital drawers to extract the professional record of the authenticated health registrant. The step of enabling display 220 further includes step of enabling display of the extracted professional record including area of specialization of the authenticated health registrant. The method 200 further includes step of accepting health records, professional records and interfaces, and updating the digital chest of drawers based on the accepted health records, professional records and interfaces 222.

The method 200 also includes step of encoding the plurality of smart cards with information related to respective profile registrants including profile registrants' identification information. Further, it includes step of sorting the extracted health records based on the area of specialization of the authenticated health registrant and/or on a pre-determined set of rules and/or on a pre-determined preference and step of storing information related to insurance providers and details related to profile registrants' insurance covers. It also comprises step of automatically linking the stored insurance related information to provide relevant insurance covers to the profile registrants. Additionally, the method 200 includes step of providing suggestion to profile registrants based on profile registrants' demographic information and demands, wherein the suggestion includes a suitable insurance plan and a nearby healthcare provider. The method 200 also includes steps of providing customer service to the profile registrants, providing training sessions selected from a group consisting of training on sample collection, data updating, volume data management, inventory management and the like, providing self-management support and decision support for diseases, facilitating integration with other medical systems and providing techniques including workforce optimization, quality monitoring and recording, workforce management, performance management, desktop and process analytics, eLearning, coaching, speech analytics, text analytics, enterprise feedback management, customer feedback surveys, fraud prevention and identity authentication, and the like.

### TECHNICAL ADVANCEMENTS

A computer implemented personalized health record system and a method thereof in accordance with the present disclosure described herein above has several technical advancements including but not limited to the realization of:
a personalized health record system that can be accessed by registrants/health professionals/patients irrespective of their location;
a system that allows access to health records for medical response/diagnosis/treatment;
a system that stores, provides and updates health records irrespective of place and time;
a system that is configured to connect to different medical centers, doctors, hospitals, pathology laboratories, chemists and insurance providers;
a system that enables secure remote access to health records of patients;
a system that enables multi-regional, multi-lingual, multi-medical-coded and multi-platform support; and
a system that enables ease of access to health records in case of emergency situations.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A computer implemented personalized health record system, said system comprising:
a plurality of smart cards, each having a unique identification number and each being associated with a profile registrant; and
a server comprising:
a registration module configured to register health registrants and profile registrants;
a digital chest of drawers, said digital chest comprising:
a first set of digital drawers configured to store health records, a unique identification number and a password associated with each profile registrant;
a second set of digital drawers configured to store professional records including area of specialization and authentication credentials of each health registrant; and
a third set of digital drawers configured to store a plurality of interfaces, each interface being linked to at least one platform thereby enabling said digital chest of drawers to be accessed by a plurality of platforms;
an accessing module configured to permit profile registrants and health registrants to access said digital chest of drawers on a registrant's selected platform to enable a profile registrant to view his/her health record and to enable a health registrant to view and update a selected profile registrant's health record;
an identifier configured to identify a suitable interface from said plurality of interfaces stored in the third set of digital drawers to interface said selected platform with said system;
a first authenticator configured to authenticate profile registrants;
a second authenticator configured to authenticate health registrants;
at least one crawler and extractor adapted to extract health record of an authenticated profile registrant and professional record of an authenticated health registrant;
a display module configured to cooperate with said at least one crawler and extractor to enable display of the extracted health record of the authenticated profile registrant either on a display device of the authenticated profile registrant and/or of the authenticated health registrant; and
an updater configured to accept health records, professional records and interfaces, and update said digital chest of drawers based on the accepted health records, professional records and interfaces.

2. The system as claimed in claim 1, wherein said smart cards are encoded with information related to respective profile registrants including profile registrants' identification information and are rewritable.

3. The system as claimed in claim 1, wherein
said registration module comprises a first input module configured to accept demographic information, credentials and health records of the profile registrants, and professional records of the health registrants, for registration;
said first authenticator comprises a smart card reader configured to cooperate with said plurality of smart cards to identify unique identification numbers of said smart cards, a second input module configured to accept passwords from said profile registrants, and a first comparator configured to compare the accepted passwords with the passwords stored in the first set of digital drawers to authenticate said profile registrants;
and
said second authenticator comprises a third input module configured to accept authentication credentials from said health registrants, and a second comparator configured to compare the accepted authentication credentials with the authentication credentials stored in the second set of digital drawers to authenticate said health registrants.

4. The system as claimed in claim 1, wherein said at least one crawler and extractor is adapted to cooperate with said first authenticator to receive a unique identification number of an authenticated profile registrant and configured to crawl through said first set of digital drawers to extract said health record of the authenticated profile registrant, said least one crawler and extractor is further adapted to cooperate with said second authenticator to receive authentication credentials of an authenticated health registrant and configured to crawl through said second set of digital drawers to extract said professional record of the authenticated health registrant.

5. The system as claimed in claim 1, wherein said display module is configured to enable display of the extracted professional record including area of specialization of the authenticated health registrant.

6. The system as claimed in claim 1, wherein said server comprises a sorter adapted to cooperate with said at least one crawler and extractor, and configured to sort the extracted health records based on the area of specialization of the authenticated health registrant, said sorter is further configured to sort the health records based on a pre-determined set of rules and a pre-determined preference.

7. The system as claimed in claim 1, wherein said server is configured to store information related to insurance providers and details related to profile registrants' insurance covers and said system is configured to automatically link the stored insurance related information to provide relevant insurance covers to the profile registrants.

8. The system as claimed in claim 1, which is configured to
extract a suitable interface from external sources, if a suitable interface is not stored in the third set of digital drawers, and update the third set of digital drawers to include the extracted suitable interface; and
provide suggestion to profile registrants based on profile registrants' demographic information and demands, said suggestion includes a suitable insurance plan and a nearby healthcare provider.

9. The system as claimed in claim 1, wherein said authentication credentials are stored in a repository of a medical council.

10. The system as claimed in claim 1, which further comprises:
a customer service module configured to provide customer service to the profile registrants;
a training module configured to provide training sessions selected from a group consisting of training on sample collection, data updating, volume data management and, inventory management;
an illness information management module configured to provide self-management support and decision support for diseases;
a vendor management module configured to facilitate integration with other medical systems; and
a knowledge processing unit configured to provide techniques including workforce optimization, quality monitoring and recording, workforce management, performance management, desktop and process analytics, eLearning, coaching, speech analytics, text analytics, enterprise feedback management, customer feedback surveys and, fraud prevention and identity authentication.

11. A method for implementing a personalized health record system, said method comprising the following:
associating a plurality of smart cards, each having a unique identification number, with a profile registrant;
registering health registrants and profile registrants;
storing health records, a unique identification number and a password associated with each profile registrant in a first set of digital drawers from a digital chest of drawers;
storing professional records including area of specialization and authentication credentials of each health registrant in a second set of digital drawers from said digital chest of drawers;
storing a plurality of interfaces in a third set of digital drawers from said digital chest of drawers and, linking each interface to at least one platform thereby enabling said digital chest of drawers to be accessed by a plurality of platforms;
permitting profile registrants and health registrants to access said digital chest of drawers on a registrant's selected platform to enable a profile registrant to view his/her health record and to enable a health registrant to view and update a selected profile registrant's health record;
identifying a suitable interface from said plurality of interfaces stored in the third set of digital drawers to interface said selected platform with said system;
authenticating profile registrants;
authenticating health registrants;
extracting health record of an authenticated profile registrant and professional record of an authenticated health registrant;
enabling display of the extracted health record of the authenticated profile registrant either on a display device of the authenticated profile registrant and/or of the authenticated health registrant; and
accepting health records, professional records and interfaces, and updating said digital chest of drawers based on the accepted health records, professional records and interfaces.

12. The method as claimed in claim 11, wherein said step of registering health registrants and profile registrants includes steps of accepting demographic information, credentials and health records of the profile registrants, and professional records of the health registrants, for registration;

13. The method as claimed in claim 11, wherein said step of authenticating profile registrants comprises the following:
reading the plurality of smart cards and identifying unique identification numbers of said smart cards;
accepting passwords from said profile registrants; and
comparing the accepted passwords with the passwords stored in the first set of digital drawers to authenticate said profile registrants.

14. The method as claimed in claim 11, wherein said step of authenticating health registrants comprises the following:
accepting authentication credentials from said health registrants; and
comparing the accepted authentication credentials with the authentication credentials stored in the second set of digital drawers to authenticate said health registrants.

15. The method as claimed in claim 11, wherein said step of extracting health record and professional record includes the following:
receiving a unique identification number of an authenticated profile registrant and crawling through said first set of digital drawers to extract said health record of the authenticated profile registrant; and
receiving authentication credentials of an authenticated health registrant and crawling through said second set of digital drawers to extract said professional record of the authenticated health registrant.

16. The method as claimed in claim 11, wherein said step of enabling display further includes step of enabling display of the extracted professional record including area of specialization of the authenticated health registrant.

17. The method as claimed in claim 11, wherein said step of identifying a suitable interface includes step of extracting a suitable interface from external sources, if a suitable interface is not stored in the third set of digital drawers, and updating the third set of digital drawers to include the extracted suitable interface.

18. The method as claimed in claim 11, which comprises step of providing suggestion to profile registrants based on profile registrants' demographic information and demands, said suggestion including a suitable insurance plan and a nearby healthcare provider.

19. The method as claimed in claim 11, wherein said step of storing authentication credentials of health registrants includes step of obtaining authentication credentials from a repository of a medical council.

20. The method as claimed in claim 11, which further comprises the following:
encoding the plurality of smart cards with information related to respective profile registrants including profile registrants' identification information;
sorting the extracted health records based on the area of specialization of the authenticated health registrant and/or on a pre-determined set of rules and/or on a pre-determined preference;
storing information related to insurance providers and details related to profile registrants' insurance covers and further comprises step of automatically linking the stored insurance related information to provide relevant insurance covers to the profile registrants;
providing customer service to the profile registrants;
providing training sessions selected from a group consisting of training on sample collection, data updating, volume data management and, inventory management;
providing self-management support and decision support for diseases;
facilitating integration with other medical systems; and
providing techniques including workforce optimization, quality monitoring and recording, workforce management, performance management, desktop and process analytics, eLearning, coaching, speech analytics, text analytics, enterprise feedback management, customer feedback surveys and, fraud prevention and identity authentication.
